(19) United States
(12) Patent Application Publication
(10) Pub. No.: US 2005/0145614 A1
(43) Pub. Date: Jul. 7, 2005

(54) Rapid temperature compensation module for semiconductor tool

(75) Inventors: Hsueh-Chang Wu, Hsin-Chu (TW); Chih-Tien Chang, Hsin-Chu (TW); Jhi-Cherng Lu, Hsin-Chu (TW); Bing-Hung Chen, Hsin-Chu (TW); Mei-Sheng Zhou, Singapore (SG)

Correspondence Address: HAYNES AND BOONE, LLP, 901 MAIN STREET, SUITE 3100, DALLAS, TX, 75202, US

(73) Assignee: Taiwan Semiconductor Manufacturing Co., Ltd., Hsin-Chu (TW)

(21) Appl. No.: 10/753,253

(22) Filed: Jan. 5, 2004

(51) Int. Cl. F27B 5/14; F27D 11/00

(52) U.S. Cl. 219/390; 219/444.1; 219/443.1

(57) ABSTRACT

A semiconductor device manufacturing system including a processing subsystem and a compensation thermal subsystem. The processing subsystem includes a process chamber and a thermal control subsystem having a processing subsystem heating element and configured to generate a process chamber temperature profile. The compensation thermal subsystem includes a temperature sensor configured to detect the process chamber temperature profile, a compensation thermal control unit (CTCU) configured to determine variation between the process chamber temperature profile and a desired temperature profile, and a compensation heating element configured to alter the process chamber temperature profile in response to the variation detected by the CTCU.

### BACKGROUND

The present disclosure relates generally to semiconductor manufacturing tools and, more specifically, to rapid temperature compensation for semiconductor manufacturing tools.

The semiconductor integrated circuit (IC) industry has experienced rapid growth since the invention of the integrated circuit in 1960, such as from the primary IC to large scale IC (LSIC), to very large scale IC (VLSI), and to ultra-large scale IC (ULSI) by technological progress in materials, design, processing and fabrication tools and equipment. Technological advances in IC materials and design have produced generations of ICs where each generation has smaller and more complex circuits than the previous generation, such as from the micron generation to the submicron generation, and then to the deep-submicron generation. However, these advances have increased the complexity of fabricating ICs.

In many semiconductor tools, process temperatures need to be controlled in a predetermined temperature profile over a period of time, such as in tools employed during chemical vapor deposition (CVD), sputtering, thermal oxidation, diffusion and etching. For example, with IC feature size scaling down to deep-submicron, it is required that the thickness of the oxygenated gate in the MOSFET scales down towards 50 Angstroms or less, which will be more sensitive to thermal profile and processing time. A traditional high-temperature thermal oxidation method may not insure high quality of super-thin oxygenated layers. In order to obtain a high quality, super-thin oxygenated layer, rapid thermal processing (RTP) may be employed to precisely control thermal power and temperature. As an example, one issue of temperature ramping in semiconductor tools is that the first one or more wafers in a processing lot may not experience the same thermal profile as that of subsequently processed wafers. The deviation may diminish product yield and device performance. Employing dummy wafers in such systems may avoid the thermal deficiency or defects but will decrease product yield and increase costs.

Accordingly, what is needed in the art is a thermal compensation system and method that addresses the above-discussed issues.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 illustrates a block diagram of one embodiment of a semiconductor device manufacturing system including a temperature control subsystem and a compensation thermal subsystem constructed according to aspects of the present disclosure.

FIG. 2 illustrates a block diagram of one embodiment of the temperature control subsystem shown in FIG. 1.

FIG. 3 illustrates a schematic view of one embodiment of a portion of a semiconductor device manufacturing system constructed according to aspects of the present disclosure.

FIG. 4 illustrates a flow chart of one embodiment of a method of correcting variation between a process chamber temperature profile and a desired temperature profile according to aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

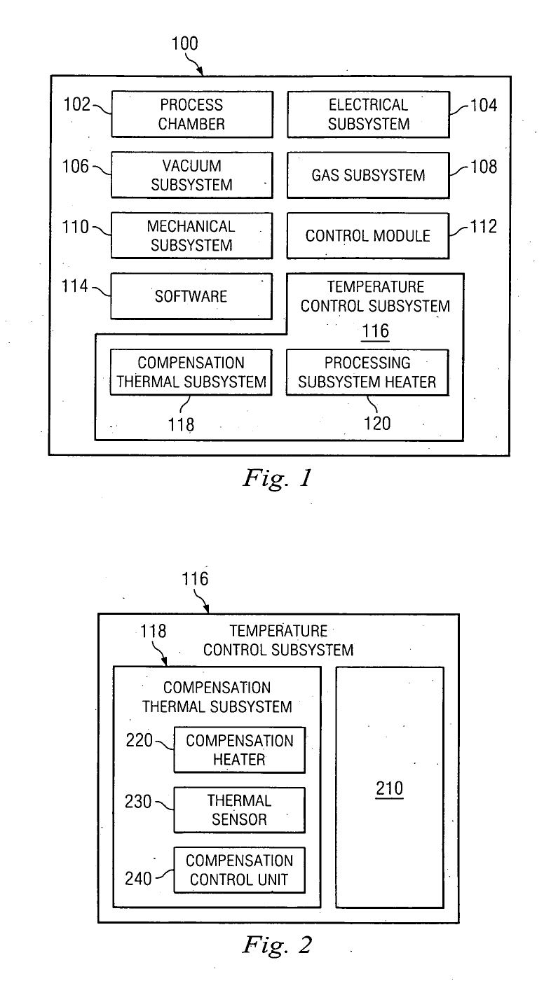

Referring to FIG. 1, illustrated is a block diagram of one embodiment of a semiconductor device manufacturing system 100 constructed according to aspects of the present disclosure. The system 100 may be, comprise, or be included in a single processing tool or a cluster tool for processing semiconductor devices on wafers of any size, including wafer diameters of 150 mm, 200 mm, and 300 mm. The system 100 may also be employed for any technology node including micron, submicron, and deep-submicron, including 0.5 μm, 0.25 μm, 0.18 μm, 0.13 μm and below.

For example, the system 100 may be a tool employed for chemical vapor deposition (CVD), such as plasma enhanced CVD (PECVD), low pressure CVD (LPCVD) or high density plasma CVD (HDP-CVD). The system 100 may also be a tool employed for physical vapor deposition (PVD), such as sputtering or ion metal plasma (IMP) PVD. The system 100 may also be a tool employed for anion implantation, diffusion, etching, thermal oxidation and/or rapid thermal processing (RTP).

The system 100 may include one or more process chambers 102, an electrical subsystem 104, a vacuum subsystem 106, a gas subsystem 108, a mechanical subsystem 110, a control module 112, software 114, and a temperature control subsystem 116. The system 100 also includes a compensation thermal subsystem 118. Additional and/or alternative subsystems may be included in the system 100 to expand its function and application. For example, a residual gas analysis (RGA) subsystem may also be included to monitor contamination and perform processing correlation analysis, or a network interface may be included for control via an intranet and/or the internet.

The process chamber 102 provides an enclosed environment in which processing of one or more semiconductor wafers may be performed. For example, the temperature, pressure, processing contents (e.g., etchant chemistries) and other parameters of a processing environment within the process chamber 102 may be altered as necessary to perform desired semiconductor processing operations. Moreover, these parameters may be altered or otherwise controlled by the subsystems in the system 100, such as the control module 112.

The electrical subsystem 104 may include means for communication of power, data, control and other signals between the various subsystems of the system 100. The vacuum subsystem 106 may include one or more pumps configured to remove processing gases, etching chemistries and other materials from the process chamber 102. The vacuum subsystem 106 may include both rough pumps and high vacuum pumps such as oil-sealed rotary mechanical pumps, roots pumps, dry mechanical pumps, cryo-pumps, and turbo-molecular pumps. The vacuum system 106 may be coupled directly or indirectly to the process chamber 102, or may be integral to the process chamber 102.

The gas subsystem 108 may supply argon, nitrogen, oxygen, or/and other gases employed during CVD and other semiconductor device manufacturing processes. Master flow control (MFC) and various types of sensors such as chemical sensors may be employed to sustain a pressure or fractional pressure at a predetermined value or profile, or to control flow rate at a predetermined level.

The mechanical subsystem 110 may include robotic and/or hand-operable means for transferring wafers within the system 100. The mechanical subsystem 110 may also include mechanical modules to lift wafers from a substrate or lower wafers onto a support platform or other substrate.

The control module 112 may include hardware, sensors to detect temperature, pressure and other process parameters, and a computer to control processing the system 100. The software 114, which may be integral to the control module 112, may include programming code and one or more databases. The programming code may include tool operating code and a manufacturing execution system (MES). The databases may include a processing recipe database, a process steps database and a tolerance alarm database.

The temperature control subsystem 116 provides temperature control to the process chamber 102 according to a desired temperature profile predetermined in a processing recipe. The desired temperature profile may be a constant temperature sustained for a predetermined period of time or may vary as a function of time. The temperature control subsystem 116 may include one or more processing system heater elements 120 for affecting the thermal environment within the process chamber 102. The temperature control subsystem 116 may also include the compensation thermal subsystem 118 as integral thereto, as shown in the embodiment illustrated in FIG. 1. However, in one embodiment, the compensation thermal subsystem 118 may be separate from (e.g., external to) the temperature control subsystem 116.

Referring to FIG. 2, illustrated is a block diagram of one embodiment of the temperature control subsystem 116 shown in FIG. 1. As discussed above, the compensation thermal subsystem 118 may be a module within the temperature control subsystem 116. Moreover, the temperature control subsystem 116 may comprise additional and/or alternative modules, elements or subsystems 210 within the scope of the present disclosure. For example, additional elements 210 which may be integral to the temperature control subsystem 116 may include computer processing and and/or storage means, a user interface, a network interface, etc.

The compensation thermal subsystem 118 includes a compensation heater element 220, a temperature sensor 230, and a compensation thermal control unit (CTCU) 240. The compensation heater element 220 may include one or more heater elements located inside the process chamber 102 shown in FIG. 1 in an orientation configured to effect the thermal environment within the process chamber in coordination with the processing system heater elements 120. The processing system heater elements 120 and the compensation heater elements 220 may each be or comprise an electric bulb or other type of heat lamp, an infrared energy source, a laser, a heater wire or loop and/or other heater elements.

The temperature sensor 230 may include one or more temperature sensors placed in random or predetermined locations within the process chamber 102 so as to detect a temperature or temperature profile within the process chamber (referred to herein as the “process chamber temperature profile”). The temperature sensor 230 may be or comprise an infrared sensor, a thermistor, a thermocouple and/or other types of temperature sensing devices. The temperature sensor 230 may also include a transmitter for transmitting detected temperature data to the CTCU 240. Such transmission may be wired or wireless, digital or analog, and electrical, mechanical or magnetic.

The CTCU 240 may comprise electrical circuits, computer processing and memory storage devices, software, and databases of process parameters and/or other data. The CTCU 240 may also include a receiver or other scanning apparatus to collect temperature data detected by the temperature sensor 230. Alternatively, the CTCU 240 may include one or more receivers for receiving such data as transmitted by the temperature sensor 230. The CTCU 240 employs the temperature data, which is indicative of the process chamber temperature profile, to control the compensation heater element 220, thereby correcting any undesired variation between the process chamber temperature profile and a desired temperature profile for the semiconductor manufacturing process being performed in the process chamber 102.

Temperature ramping deficiencies (or other types of thermal profile deficiencies) encountered in semiconductor manufacturing may originate from inefficient and/or latent generation of thermal energy due to limitations, dilapidation or failure of the temperature control subsystem 116. Consequently, a desired process temperature or temperature profile may not be attainable with the temperature control subsystem 116, such that resulting semiconductor devices may be faulty or perform poorly. For example, the time required to elevate the process environment to a target temperature may be longer than desired (e.g., an insufficient ramp rate). Accordingly, the first one or more wafers in a process flow may experience a processing chamber thermal profile that varies from the desired or target thermal profile called for in the manufacturing recipe corresponding to the semiconductor device being manufactured. However, the compensation thermal subsystem 118 may correct these variations by introducing additional thermal energy to the process chamber 102 in response to the process chamber temperature profile detected by the thermal sensors 230 and/or the CTCU 240.

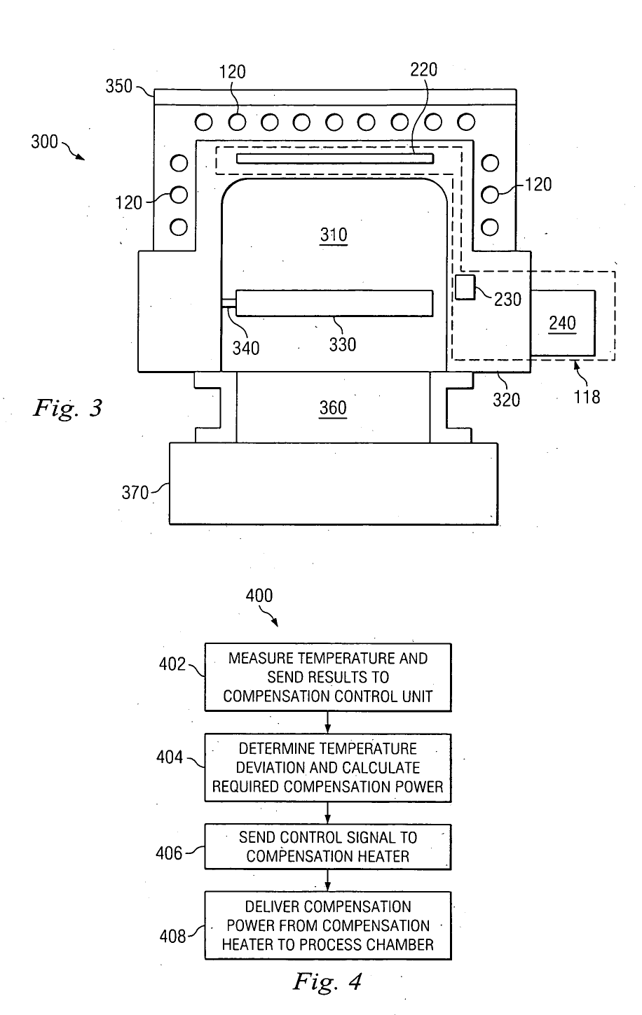

Referring to FIG. 3, illustrated is a schematic view of one embodiment of a portion of a semiconductor device manufacturing system 300 constructed according to aspects of the present disclosure. The system 300 is one environment in which the system 100 shown in FIG. 1. may be implemented. The system 300 may also form at least portion of the system 100, and may be substantially similar to the system 100.

The system 300 includes a process chamber 310 which may be supported by or defined in a housing 320 comprising ceramic material and having a well polished interior surface for optimized radiation reflection and heating efficiency. The process chamber 310 is configured to house one or more semiconductor wafers 330. In one embodiment, the semiconductor wafer 330 may interchangeably include a dummy wafer and a target work piece during processing. The wafer 330 is supported by an arm or pin structure 340 which may comprise quartz and extend from an inner wall of the process chamber 310. The system 300 and, hence, the process chamber 310, may be configured or configurable for myriad semiconductor manufacturing processes, including deposition, etching, diffusion, oxidation, and other thermal processes.

The system 300 may also include a heating/cooling plate 350 comprising a thermally conductive material to assist in heat transfer to and from the process chamber 310. The heating/cooling plate 350 may help maintain uniformity of the temperature within the process chamber 310, such that thermal gradients are prevented or minimized within the chamber 310.

The system 300 also includes processing subsystem heater elements 120 which are substantially similar to the processing subsystem heater element 120 described above. The processing subsystem heater elements 120 shown in FIG. 3 may be located above and/or below the wafer 330 inside the process chamber 310.

The system 300 may also include a throttle and gate valve assembly 360 for connection to and/or control of the interface between the process chamber 310 and a vacuum subsystem 370. The vacuum subsystem 370 may be similar to the vacuum subsystem 106 shown in FIG. 1. For example, the vacuum subsystem 370 may include rough pumps, turbo-molecular pumps, and/or cryopumps. The vacuum subsystem 370 in combination with a gas source may provide a low pressure, chemical environment required for many semiconductor manufacturing procedures, such as a nitrogen, argon or other inert gas environments for RTP or rapid thermal annealing (RTA), an oxygen environment for thermal oxidation, an argon and nitrogen environment for sputtering, and similar or other chemical environments for CVD.

The process system 300 also includes a compensation thermal subsystem 118 that is substantially similar to the compensation thermal subsystem 118 shown in FIG. 2. The compensation thermal subsystem 118 includes a compensation heater element 220, a temperature sensor 230, and a CTCU 240. The temperature sensor 230 may comprise a plurality of sensors, and may be placed in random or predetermined locations in or proximate the process chamber 310, such as proximate the wafer 330, the compensation heater element 220, and the process subsystem heater elements 120. The CTCU 240 may be integral to the housing 320, such as by being coupled or otherwise located in a recess of the housing 320. However, the CTCU 240 may also be a separate component which, as shown in FIG. 3, is coupled to an external surface of the housing 320. Of course, in other embodiments, the CTCU 240 may be located distal from the housing 320, such that the CTCU 240 and the remainder of the system 300 may only be coupled by wired or wireless communication means.

Referring to FIG. 4, illustrated is flow chart of one embodiment of a method 400 of correcting variation between a process chamber temperature profile and a desired temperature profile according to aspects of the present disclosure. Additional references are made to FIG. 2 and FIG. 3 while describing the method 400. The method 400 may be implemented via the system 100 shown in FIG. 1 and/or the system 300 shown in FIG. 3.

The method 400 may begin in step 402 during which the temperature sensors 230 detect the processing chamber temperature profile. In one embodiment, such detection may include measuring the temperature within the processing chamber 310 proximate the wafer 330, processing subsystem heater elements 120 and the compensation heater element 220. Step 402 may also include transmitting the detected thermal data regarding the processing chamber temperature profile to the CTCU 240.

In a subsequent step 404, the CTCU 240 calculates the power required for the compensation heater element 220 to correct any variation between the processing chamber temperature profile and the desired temperature profile. For example, the power may be determined according to the difference between the processing chamber temperature profile and the desired temperature profile using a predefined function. This determination may employ the raw data detected by the temperature sensor 230, such that any variation between the processing chamber temperature profile and the desired temperature profile may be determined before the power required for compensation is determine. The variation may also be determined concurrently with the determination of the power required for compensation. The detected temperature data may also be allocated different weights to account for known or suspected thermal gradients within the process chamber 310 or known or suspected deficiencies or inefficiencies of the system 300 (possibly deduced from repeated performance of the method 400). In embodiments in which the compensation heater element 220 includes a plurality of heater elements, the calculation of the power required for compensation may also include determining the power required for each individual heater element. The compensation thermal subsystem 118 may form a closed feedback loop extending from the temperature sensor 230 to the CTCU 240, to the compensation heater element 220, and then back to the temperature sensor 230. Consequently, the compensation power may also be dynamically adjusted.

To implement temperature compensation, the predetermined function to calculate the required compensation power may be proportional to the difference between the measured temperature and set temperature, or may be related to the integral of the difference over time, or may be related to the derivative of the difference over time, or may be a combination of these.

In step 406, the compensation control unit 206 sends a parameter or a set of parameters of the required compensation power to the compensation heater element 220. The required compensation power may be a parameter for a single compensation heater element, or may be a set of parameters, wherein each parameter is associated with a corresponding one of several compensation heater elements.

In step 408, the compensation heater element 220 are tuned to the required power according to the parameter(s) received in step 406 thereby imparting a prescribed amount of thermal energy to the process chamber 310 to correct the variation between the process chamber temperature profile and the desired temperature profile. Moreover, if the compensation heater element 220 comprises a plurality of compensation heater elements, each of compensation heater elements may be set to different power levels and, therefore, deliver different thermal energy levels to the process chamber 310.

Thus, the present disclosure introduces a semiconductor device manufacturing system having a processing subsystem and a compensation thermal subsystem. The processing subsystem includes a process chamber and a thermal control subsystem having a processing subsystem heating element and configured to generate a process chamber temperature profile. In one embodiment, the compensation thermal subsystem includes a temperature sensor configured to detect the process chamber temperature profile, a CTCU configured to determine variation between the process chamber temperature profile and a desired temperature profile, and a compensation heating element configured to alter the process chamber temperature profile in response to the variation detected by the CTCU.

The present disclosure also provides a compensation thermal subsystem for use with a process chamber and a thermal control subsystem within a semiconductor device manufacturing system, the thermal control subsystem having a processing subsystem heating element configured to generate a process chamber temperature profile. In one embodiment, the compensation thermal subsystem includes a temperature sensor configured to detect the process chamber temperature profile, a CTCU configured to determine variation between the process chamber temperature profile and a desired temperature profile, and a compensation heating element configured to alter the process chamber temperature profile in response to the variation detected by the CTCU.

A method of correcting variation between a desired temperature profile and a process chamber temperature profile generated in a process chamber by a processing subsystem heating element integral to a processing system thermal control subsystem within a semiconductor device manufacturing system is also provided in the present disclosure. In one embodiment, the method includes detecting the process chamber temperature profile, determining a variation between the process chamber temperature profile and the desired temperature profile, and adjusting power delivered to a compensation heating element based on the variation.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

1. A semiconductor device manufacturing system, comprising:
a processing subsystem including:
a process chamber; and
a thermal control subsystem having a processing subsystem heating element and configured to generate a process chamber temperature profile; and
a compensation thermal subsystem, including:
a temperature sensor configured to detect the process chamber temperature profile;
a compensation thermal control unit (CTCU) configured to determine variation between the process chamber temperature profile and a desired temperature profile; and
a compensation heating element configured to alter the process chamber temperature profile in response to the variation detected by the CTCU.

2. The system of claim 1 wherein the compensation heating element comprises a plurality of compensation heating elements.

3. The system of claim 1 wherein the compensation heating element comprises a heat lamp bulb.

4. The system of claim 1 wherein the compensation heating element comprises an infrared energy source.

5. The system of claim 1 wherein the compensation heating element comprises a laser.

6. The system of claim 1 wherein the compensation heating element comprises heater wire.

7. The system of claim 1 wherein the temperature sensor comprises a plurality of temperature sensors.

8. The system of claim 1 wherein the temperature sensor comprises an infrared sensor.

9. The system of claim 1 wherein the temperature sensor comprises a thermistor.

10. The system of claim 1 wherein the temperature sensor comprises a thermocouple.

11. The system of claim 1 wherein the process chamber temperature profile is detected as a function of time.

12. The system of claim 1 wherein compensation heating element is configured to alter the process chamber temperature profile by adjusting power delivered to the compensation heating element.

13. The system of claim 12 wherein the power is proportional to a quantitative difference between the process chamber temperature profile and the desired temperature profile.

14. The system of claim 12 wherein the power is related to a mathematical integral of the quantitative difference between the process chamber temperature profile and the desired temperature profile with respect to time.

15. The system of claim 12 wherein the power is related to a mathematical derivative of the quantitative difference between the process chamber temperature profile and the desired temperature profile with respect to time.

16. A compensation thermal subsystem for use with a process chamber and a thermal control subsystem within a semiconductor device manufacturing system, the thermal control subsystem having a processing subsystem heating element configured to generate a process chamber temperature profile, the compensation thermal subsystem comprising:
a temperature sensor configured to detect the process chamber temperature profile;
a mechanism to determine variation between the process chamber temperature profile and a desired temperature profile; and
a compensation heating element configured to alter the process chamber temperature profile in response to the variation detected by the CTCU mechanism.

17. A method of correcting variation between a desired temperature profile and a process chamber temperature profile generated in a process chamber by a processing subsystem heating element integral to a processing subsystem thermal control subsystem within a semiconductor device manufacturing system, comprising:
detecting the process chamber temperature profile;
determining a variation between the process chamber temperature profile and the desired temperature profile for the process chamber; and
adjusting power delivered to a compensation heating element based on the variation.

18. The method of claim 17 wherein the power is proportional to a quantitative difference between the process chamber temperature profile and the desired temperature profile.

19. The method of claim 17 wherein the power is related to a mathematical integral of the quantitative difference between the process chamber temperature profile and the desired temperature profile with respect to time.

20. The method of claim 17 wherein the power is related to a mathematical derivative of the quantitative difference between the process chamber temperature profile and the desired temperature profile with respect to time.
